(19) United States
(12) Patent Application Publication
(10) Pub. No.: US 2020/0300314 A1
(43) Pub. Date: Sep. 24, 2020

(54) PARTICULATE COLLECTION SYSTEMS AND METHODS

(71) Applicant: CUMMINS EMISSION SOLUTIONS INC., Columbus, IN (US)

(72) Inventors: Nathan A. Ottinger, Lenoir City, TN (US); Z. Gerald Liu, Madison, WI (US)

(73) Assignee: CUMMINS EMISSION SOLUTIONS INC., Columbus, IN (US)

(21) Appl. No.: 16/821,456

(22) Filed: Mar. 17, 2020

Related U.S. Application Data
(60) Provisional application No. 62/819,967, filed on Mar. 18, 2019.

(51) Int. Cl. F16D 65/00; B62D 63/04; F16D 55/22; B60T 1/06

(52) U.S. Cl. CPC F16D 65/0031; B60T 1/065; F16D 55/22; B62D 63/04

(57) ABSTRACT

A collection system for a vehicle that includes a chassis supporting the vehicle above a ground surface, a braking system coupled to the chassis, and a movement member supporting the chassis on the ground surface, includes a first duct, a first collecting conduit, a filter, and a fan. The first duct is configured to be coupled to the chassis proximate at least one of the braking system or the movement member such that the first duct is positioned proximate to the at least one of the braking system or the movement member. The first collecting conduit is fluidly coupled to the first duct. The filter is fluidly coupled to the first collecting conduit. The fan is fluidly coupled to the filter and configured to create a suction force. The fan, the filter, and the first collecting conduit are configured to provide the suction force to the first duct.

### CROSS-REFERENCE TO RELATED PATENT APPLICATION

This application claims the benefit of U.S. Provisional Patent Application No. 62/819,967, filed Mar. 18, 2019, the entire disclosure of which is incorporated herein by reference.

### TECHNICAL FIELD

The present application relates generally to particulate collection systems and methods for vehicles, such as those having an internal combustion engine and those without an internal combustion engine.

### BACKGROUND

Vehicles, such as automobiles, include wheels for traversing various surfaces. These wheels may generate particulates as they traverse a surface (e.g., due to friction, etc.). Vehicles also include brakes which operate to decelerate wheels. These brakes may also generate particulates.

Typically, particulates from wheels or brakes are dispersed across the various surfaces over which the vehicles traverse. The particulates dispersed from wheels and brakes may constitute approximately 25% of the total particulates dispersed by a vehicle with an internal combustion engine into the environment and greater than 25%, and possibly up to 100%, of the total particulates dispersed by hybrid vehicle or a vehicle without an internal combustion engine.

Reducing the particulates dispersed from wheels and brakes would significantly reduce the total particulates dispersed by a vehicle. In some situations, it may be desirable to decrease the total particulates dispersed by a vehicle.

### SUMMARY

In one embodiment, a collection system for a vehicle having a chassis supporting the vehicle above a ground surface, a braking system coupled to the chassis, and a movement member supporting the chassis on the ground surface, includes a first duct, a first collecting conduit, a filter, and a fan. The first duct is configured to be coupled to the chassis proximate at least one of the braking system or the movement member such that the first duct is positioned over the at least one of the braking system or the movement member. The first collecting conduit is fluidly coupled to the first duct. The filter is fluidly coupled to the first collecting conduit. The fan is fluidly coupled to the filter and configured to create a suction force. The fan, the filter, and the first collecting conduit are configured to provide the suction force to the first duct.

In another embodiment, a collection system for a vehicle that includes a chassis supporting the vehicle above a ground surface and a movement member supporting the chassis on the ground surface includes a first duct, a first collecting conduit, a filter, and a fan. The first duct is configured to be coupled to the chassis proximate the movement member such that the first duct is positioned proximate to the movement member. The first collecting conduit is fluidly coupled to the first duct. The filter is fluidly coupled to the first collecting conduit. The fan is fluidly coupled to the filter and configured to create a suction force. The fan, the filter, and the first collecting conduit are configured to provide the suction force to the first duct.

In yet another embodiment, a collection system for a vehicle that includes a chassis and a braking system coupled to the chassis includes a duct, a collecting conduit, a filter, and a fan. The duct is configured to be coupled to the chassis proximate the braking system such that the duct is positioned proximate to the braking system. The collecting conduit is fluidly coupled to the duct. The filter is fluidly coupled to the collecting conduit. The fan is fluidly coupled to the filter and configured to create a suction force. The fan, the filter, and the collecting conduit are configured to provide the suction force to the duct.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block schematic diagram of an example vehicle having an example particulate collection system;

FIG. 2 is a detailed side view of a portion of the example vehicle shown in FIG. 1;

FIG. 3 is a block schematic diagram of another example vehicle having an example particulate collection system;

FIG. 4 is a detailed side view of a portion of the example vehicle shown in FIG. 3;

FIG. 5 is a block schematic diagram of another example vehicle having an example particulate collection system;

FIG. 6 is a detailed side view of a portion of the example vehicle shown in FIG. 5; and

FIG. 7 is a block schematic diagram of yet another example vehicle having an example particulate collection system.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for collecting particulates from a vehicle. The various concepts introduced above and discussed in greater detail below may be implemented in any of numerous ways, as the described concepts are not limited to any particular manner of implementation. Examples of specific implementations and applications are provided primarily for illustrative purposes.

### I. Overview

Vehicles produce particulates which are dispersed into the surrounding environment. These particulates are primarily thought of as being present in the emissions (e.g., exhaust) of an internal combustion engine. However, a significant amount of particulates also originates from tires and braking systems of a vehicle. Friction between tires and a road, for example, may cause portions of the tires to become dislodged and strewn across the road. Additionally, the use of the braking systems generates brake dust which is dispersed into the surrounding atmosphere.

Implementations described herein relate to a vehicle having a particulate collection system that collects particulates dispersed from movement members, such as tires, and/or braking systems. The particulate collection system includes a plurality of ducts. Each of the ducts is positioned over one of the movement members and/or braking systems. By positioning the ducts in this way, the particulate collection system collects significantly more particulates than if the ducts were located near a centerline of the vehicle (i.e., away from the movement members and braking systems, etc.). The ducts are connected together via conduits and are provided a suction force by a fan. The suction force causes particulates generated by the movement members and/or braking systems to be drawn into the conduits. The fan further draws the particulates through a filter where the particulates are collected for subsequent disposal. In these ways, the vehicle described herein is capable of decreasing the amount of particulates that are dispersed from the vehicle in comparison to similar vehicles that do not include the particulate collection system described herein.

### II. Overview of a Vehicle Having a Particulate Collection System

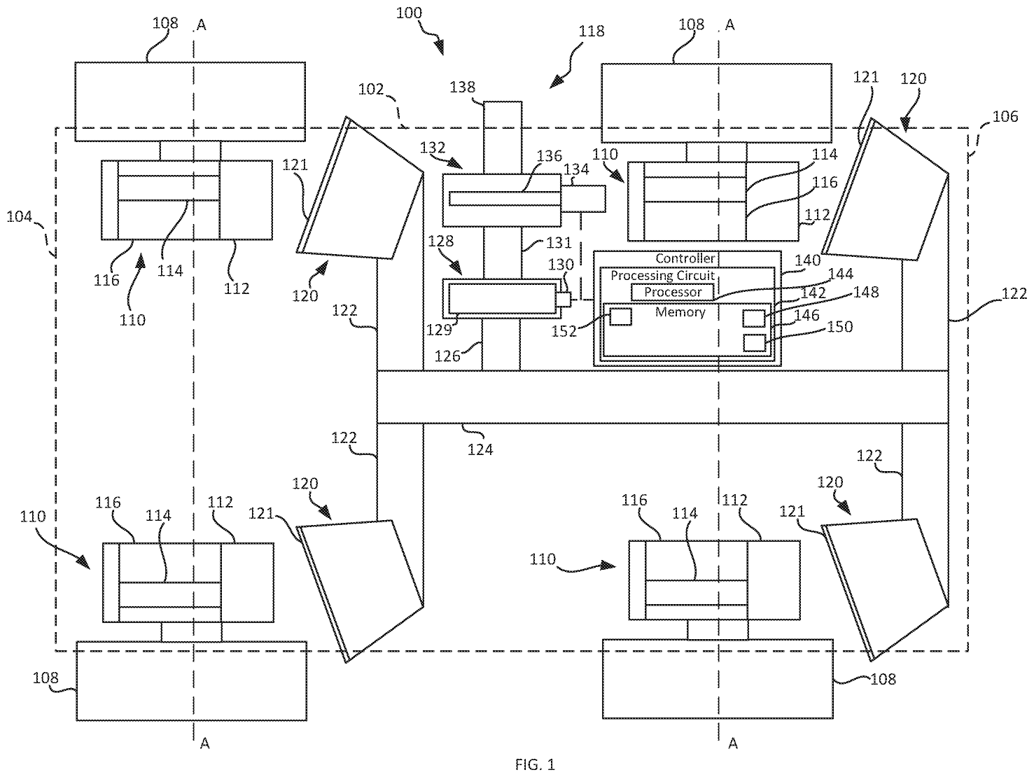

FIGS. 1-7 depict a vehicle 100 (e.g., gasoline vehicle, electric vehicle, hybrid vehicle, propane vehicle, diesel vehicle, fuel cell vehicle, internal combustion engine vehicle, etc.). In various embodiments, the vehicle 100 is an automobile (e.g., car, truck, sport utility vehicle (SUV), etc.). In other embodiments, the vehicle 100 is an industrial vehicle (e.g., construction vehicle, dump truck, tractor trailer, etc.), an emergency vehicle (e.g., fire apparatus, ambulance, etc.), municipal vehicle (e.g., school bus, mail delivery vehicle, etc.), military vehicle (e.g., transport vehicle, tank, amphibious vehicle, etc.), or other similar vehicle. The vehicle 100 includes a propulsion system (e.g., internal combustion engine, electric motor, fuel cell, etc.). The vehicle 100 may also include a transmission (e.g., automatic transmission, continuously variable transmission (CVT), etc.), a fuel source (e.g., fuel tank, fuel cell, battery, etc.), an exhaust system (e.g., an aftertreatment system, an exhaust gas recirculation system, etc.), and other similar components.

The vehicle 100 includes a chassis 102 (e.g., frame, body, etc.). The chassis 102 includes various panels, supports, arms, and other structures. The chassis 102 has a front end 104 (e.g., forward end, front end, etc.) and a rear end 106 (e.g., backward end, back end, etc.). The vehicle 100 is configured such that the front end 104 is forward when traveling in a primary direction (e.g., drive, etc.) and the rear end 106 is forward when traveling in a second direction (e.g., reverse, etc.).

The vehicle 100 also includes a plurality of movement members 108 (e.g., wheels, tires, treads, tracks, etc.). Each of the movement members 108 is coupled to the chassis 102. For example, each of the movement members 108 may be coupled to an axle that is coupled to the chassis 102. While the vehicle 100 is shown as including four movement members 108, it is understood that the vehicle 100 may include one, two, three, five, six, eight, ten, sixteen, or other numbers of the movement members 108. Each of the movement members 108 is defined by a center axis A-A. In various embodiments, two of the movement members 108 are aligned such that the movement members 108 share the same center axis A-A.

The movement members 108 traverse (e.g., roll across, contact, interface with, etc.) a surface (e.g., road, highway, dirt, gravel, sand, asphalt, concrete, etc.). As the movement members 108 traverse the surface, particulates (e.g., particles, fragments, pieces, etc.) of the movement members 108 may be generated (e.g., created, produced, etc.). For example, friction between the movement members 108 and the surface may cause production of particulates from the movement members 108. These particulates may be, for example, rubber particulates, plastic particulates, synthetic particulates, composite particulates, metallic particulates, and other similar particulates.

The vehicle 100 also includes a plurality of braking systems 110 (e.g., brakes, disc brakes, drum brakes, friction brakes, etc.). Each of the braking systems 110 is associated with one of the movement members 108 and operates to slow (e.g., decelerate, resist, etc.) rotation of one of the movement members 108. Each of the braking systems 110 includes a rotor 112 (e.g., a rotational member, etc.). Each rotor 112 is rotatably coupled to one of the movement members 108 (e.g., via lugs and lug nuts, etc.). As a result, rotation of a movement member 108 can be slowed by slowing rotation of a rotor 112.

Each of the braking systems 110 also includes a friction member 114 (e.g., brake pad, ceramic brake pad, composite brake pad, synthetic brake pad, metallic brake pad, etc.) and a friction member actuator 116 (e.g., caliper, piston, hydraulic actuator, electromechanical actuator, etc.). Each friction member actuator 116 is configured to (e.g., structured to, operable to, etc.) cause one of the friction members 114 to be pressed (e.g., biased, forced, moved, etc.) against one of the rotors 112. Each of the friction members 114 is configured to cause deceleration of one of the movement members 108 when pressed against one of the rotors 112.

Contact between one of the friction members 114 and one of the rotors 112 may generate particulates. These particulates are generated from decomposition (e.g., destruction, etc.) of the friction members 114 and/or the rotors 112. These particulates may be, for example, brake dust, metallic particulates, ceramic particulates, composite particulates, synthetic particulates, and other similar particulates. In some applications, these particulates include various combinations of aluminum, astatine, barium, calcium, cadmium, cobalt, chromium, copper, iron, potassium, magnesium, manganese, molybdenum, sodium, nickel, lead, antimony, tin, titanium, zinc, and other similar elements or combinations thereof.

While the vehicle 100 is shown as including four rotors 112, four friction members 114, and four friction member actuators 116, it is understood that the vehicle 100 may include one, two, three, five, six, eight, ten, sixteen, or other numbers of the rotors 112, friction members 114, and friction member actuators 116. In various embodiments, the vehicle 100 includes the same number of movement members 108, rotors 112, friction members 114, and friction member actuators 116. In other embodiments, the vehicle 100 includes the same number of rotors 112, friction members 114, and friction member actuators 116 and a different number of movement members 108.

The vehicle 100 also includes a particulate collection system 118 (e.g., collection system, brake dust particulate collection system, etc.). As will be described in more detail herein, the particulate collection system 118 is configured to collect particulates dispersed by at least some of the movement members 108 and/or at least some of the braking systems 110. In this way, the particulate collection system 118 reduces the total amount of particulates dispersed by the vehicle 100. As a result, the vehicle 100 may be more desirable than other vehicles which disperse particulates into the environment. For example, the particulate collection system 118 may enable the vehicle 100 to comply with regulations regarding the dispersion of particulates into the environment.

The particulate collection system 118 includes a plurality of ducts 120 (e.g., hoods, collectors, removers, etc.). Each of the ducts 120 is associated with one of the movement members 108 and is configured to collect (e.g., receive, etc.) the particulates from one of the movement members 108 and one of the braking systems 110. As will be explained in more detail herein, each of the ducts 120 provides a suction force (e.g., negative pressure, vacuum, etc.) near (e.g., proximate to, around, next to, etc.) one of the movement members 108 and/or one of the braking systems 110 which causes particulates produced by the movement member 108 and/or the braking system 110 and air proximate the movement member 108 and/or the braking system 110 to be drawn (e.g., sucked, pulled, etc.) into the duct 120.

Each of the ducts 120 is positioned over one of the movement members 108 and/or one of the braking systems 110 (e.g., such that a portion of the duct 120 is offset in at least one direction from a movement member 108, such that a portion of the duct 120 is offset in at least one direction from a braking system 110, etc.). For example, each of the ducts 120 may be positioned in various combinations of behind (e.g., on a side of the movement member 108 that is closest to the rear end 106, on a side of the braking system 110 that is closest to the rear end 106, etc.) one of the movement members 108 and/or one of the braking systems 110, in front of (e.g., on a side of the movement member 108 that is closest to the front end 104, on a side of the braking system 110 that is closest to the front end 104, etc.) one of the movement members 108 and/or one of the braking systems 110, above (e.g., on a side of the movement member 108 that is farthest from a surface upon which the movement member 108 traverses, on a side of the braking system 110 that is farthest from a surface upon which the movement member 108 traverses, etc.) one of the movement members 108 and/or one of the braking systems 110, below (e.g., on a side of the movement member 108 that is closest to a surface upon which the movement member 108 traverses, on a side of the braking system 110 that is closest to a surface upon which the movement member 108 traverses, etc.) one of the movement members 108 and/or one of the braking systems 110, and/or axially behind (e.g., offset away from the movement member 108 along an axis that is parallel to the center axis A-A, offset away from the braking system 110 along an axis that is parallel to the center axis A-A, etc.) one of the movement members 108 and/or braking systems 110. By positioning the ducts 120 in this way, the ducts 120 are capable of collecting more particulates than other systems which are positioned near a centerline (e.g., middle, etc.) of a vehicle. In these other systems, the distance between the system and the source of particulates causes a large portion of the particulates to be dispersed into atmosphere. This large portion may increase as a speed of the vehicle increases.

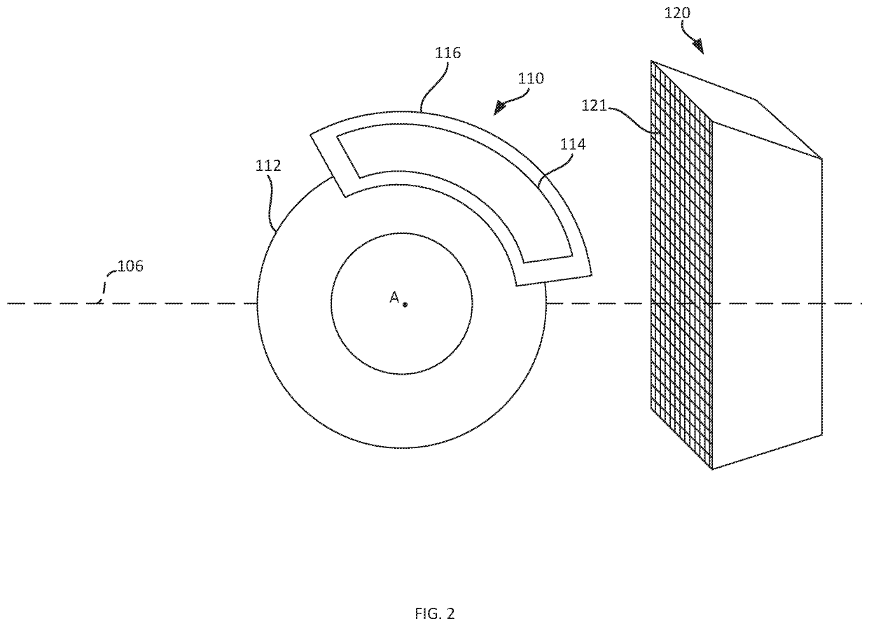

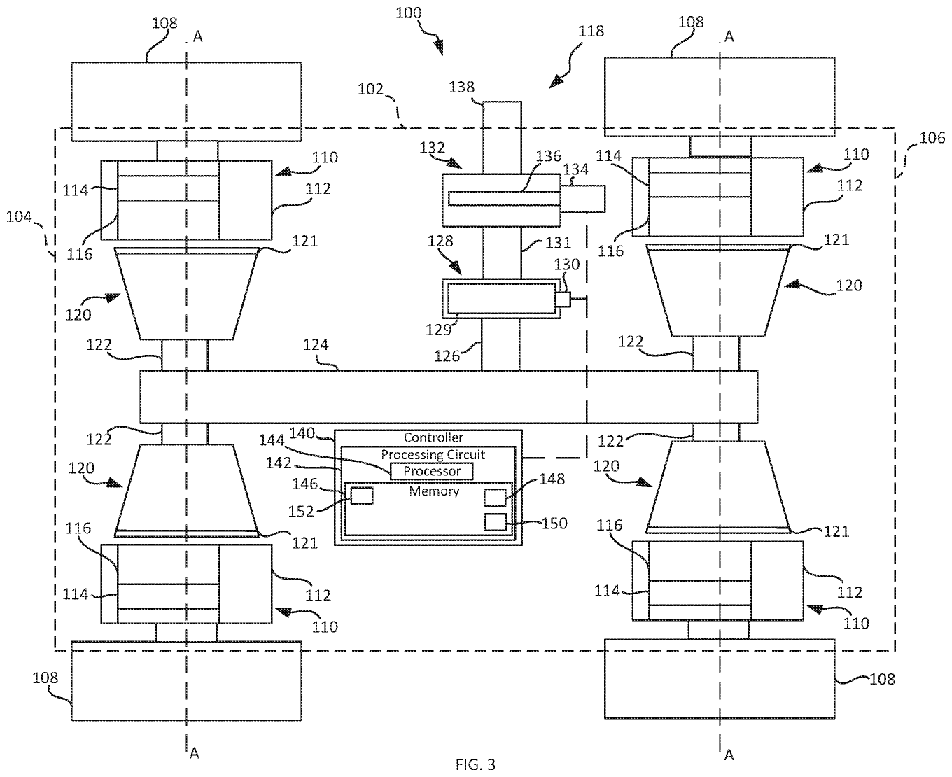

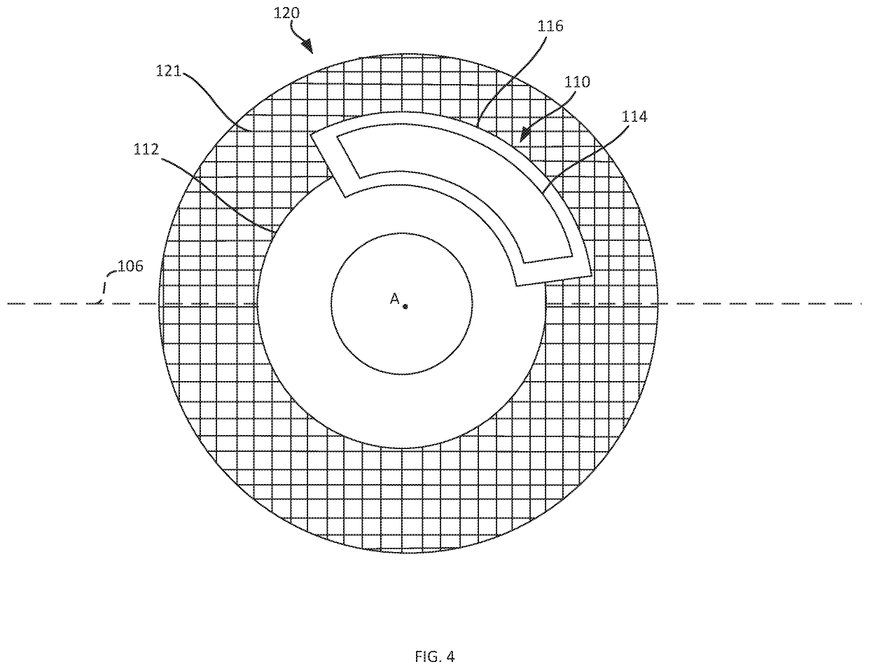

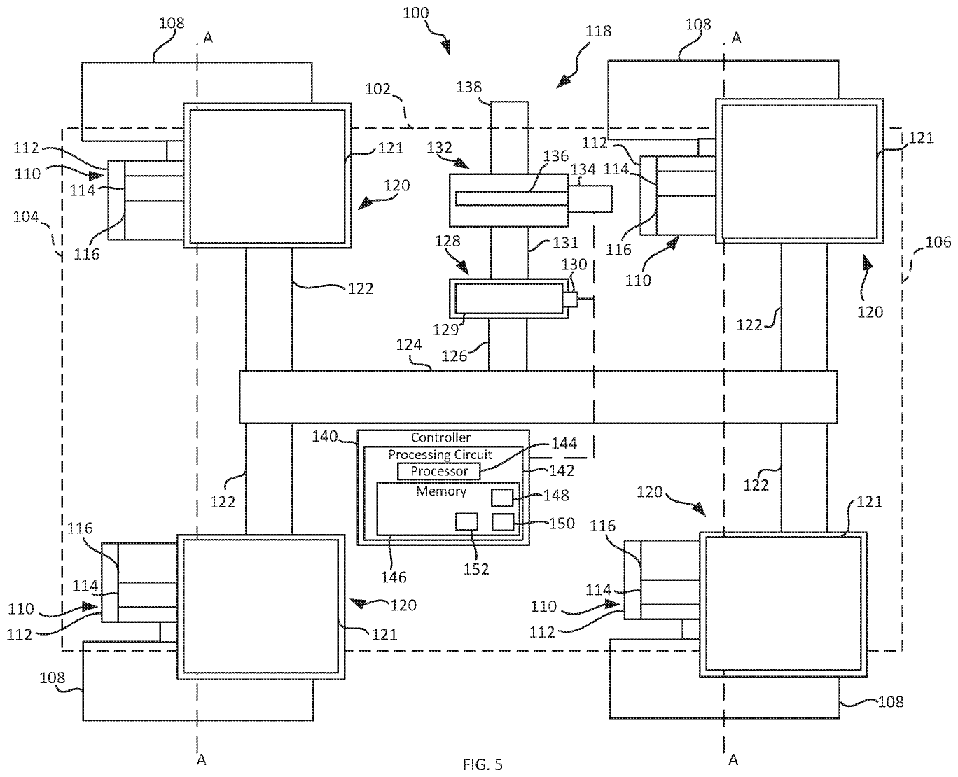

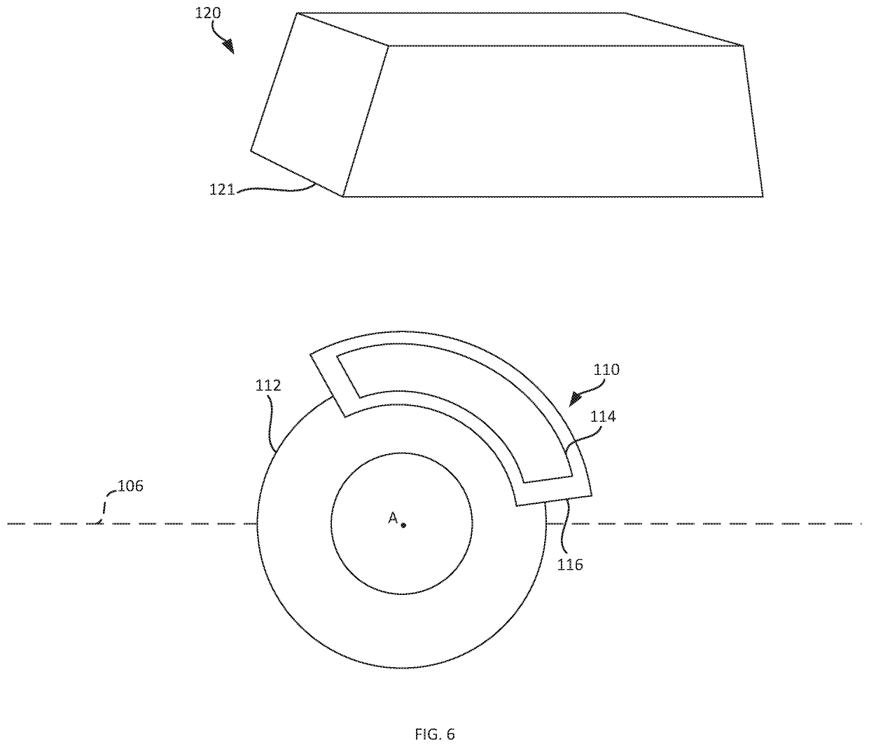

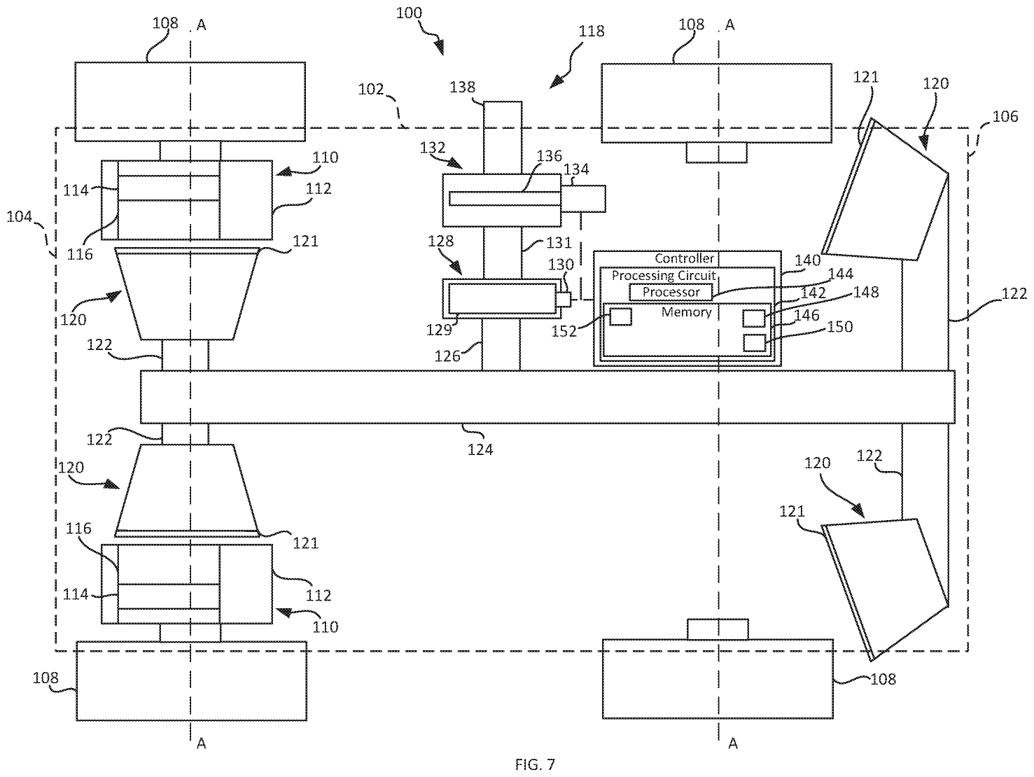

As shown in FIG. 1, each of the ducts 120 is positioned behind one of the movement members 108. FIG. 2 illustrates a detailed side view of the vehicle 100 of FIG. 1 with a movement member 108 hidden. As shown in FIG. 3, each of the ducts 120 is positioned axially behind one of the movement members 108. FIG. 4 illustrates a detailed side view of the vehicle 100 of FIG. 3 with a movement member 108 hidden. As shown in FIG. 5, each of the ducts 120 is positioned on top of one of the movement members 108. FIG. 6 illustrates a detailed side view of the vehicle 100 of FIG. 5 with a movement member 108 hidden. As shown in FIG. 7, the two ducts 120 proximate the front end 104 of the chassis 102 are positioned axially behind one of the movement members 108 and the two ducts 120 proximate the rear end 106 of the chassis 102 are positioned behind one of the movement members 108.

Each of the ducts 120 is individually positioned relative to one of the movement members 108 and/or one of the braking systems 110. The position of each of the ducts 120 may be selected so as to minimize the transmission of non-particulate substances (e.g., mud, rocks, snow, ice, road debris, twigs, gravel, sand, salt, wet asphalt, etc.) into the particulate collection system 118. In addition to the positioning each of the ducts 120 to minimize the transmission of non-particulate substances into the particulate collection system 118, the suction force provided by the particulate collection system 118 may be controlled so as to minimize the transmission of non-particulate substances into the particulate collection system 118. For example, non-particulate substances may be significantly larger (e.g., 100 times, 1,000 times, 10,000 times, etc.) than the particulates provided by the movement members 108 and/or braking systems 110 and therefore require a significantly larger force to move. By ensuring the suction force remains below a threshold (e.g., a force that may be large enough to draw certain non-particulate substances towards the particulate collection system 118, etc.) the particulate collection system 118 may ensure that the transmission of non-particulate substances into the particulate collection system 118 is minimized.

In various embodiments, each of the ducts 120 also includes a screen 121 (e.g., mesh screen, grate, etc.). Each of the screens 121 extends across one of the ducts 120 and functions to substantially prohibit transmission (e.g., 99% of transmission is prohibited, 95% of transmission is prohibited, etc.) of non-particulate substances into the duct 120. The screens 121 may be defined by an opening size such that transmission of any substance having a size greater than the opening size into the ducts 120 is substantially prohibited. In some embodiments, the opening size of the screens 121 is 1 centimeter (cm). In other embodiments, the opening size of the screens 121 is 0.5 cm. In other embodiments, the opening size of the screens 121 is 100 micrometers (μm). In other embodiments, the opening size of the screens 121 is 50 μm. In other embodiments, the opening size of the screens 121 is 25 μm. In other embodiments, the opening size of the screens 121 is 10 μm. The screens 121 may each be removable. When removed, the screens 121 may be replaced (e.g., with new screens 121, etc.) or cleaned and reinstalled. In some applications, the vehicle 100 may include multiple sets of screens 121. For example, a first set of screens 121 that has a relatively smaller opening size that is optimized for winter weather and a second set of screens 121 that has a relatively larger opening size that is optimized for summer weather (e.g., because of the persistent water on roadways in winter weather, etc.).

Additionally, each of the ducts 120 may be of various shapes and sizes. For example, each of the ducts 120 may have a width that is selected so that each of the ducts 120 extends across at least part of one of the movement members 108 and at least part of one of the braking systems 110. The ducts 120 may be fan-shaped, frustoconical, cylindrical, curved, polygonal, or otherwise similarly shaped.

The particulate collection system 118 also includes at least one collecting conduit 122 (e.g., pipe, tube, etc.) and a main conduit 124 (e.g., pipe, tube, etc.). Each of the collection conduits 122 is fluidly coupled to (e.g., in fluid communication with, etc.) one of the ducts 120 and to the main conduit 124. In operation, the ducts 120 receive particulates and air and then provide the particulates and air to the collecting conduits 122. The collecting conduits 122 further provide the particulates and air to the main conduit 124. In various embodiments, the number of collecting conduits 122 is equal to the number of ducts 120. It is understood that the collecting conduits 122 and/or main conduit 124 may be structurally integrated (e.g., of a one-piece construction, etc.) in some embodiments.

The particulate collection system 118 also includes a filter conduit 126 (e.g., pipe, tube, etc.). The filter conduit 126 is fluidly coupled to the main conduit 124 and is configured to receive the particulates and air from the main conduit 124. The particulate collection system 118 also includes a filter 128 (e.g., filter element, filtration system, etc.). The filter 128 receives the particulates and air from the filter conduit 126. The filter 128 is configured to separate (e.g., filter out, collect, etc.) at least some of the particulates from the air. The filter 128 collects (e.g., stores, holds, etc.) the particulates separated from the air and may be either replaced with another filter 128 or cleaned so as to remove at least some of the particulates collected in the filter 128.

Instead of or in addition to the screens 121, the ducts 120, the collecting conduits 122, the main conduit 124, and/or the filter conduit 126 may be configured to mitigate the transmission of non-particulate substances to the filter 128. For example, each of the ducts 120 may be coupled to one of the collecting conduits 122 at a sharp angle (e.g., 80 degree angle, 90 degree angle, 100 degree angle, etc.). This sharp angle may cause non-particulate substances to contact surfaces of the ducts 120, the collecting conduits 122, the main conduit 124, and/or the filter conduit 126, and therefore not flow towards the filter 128.

The filter 128 includes a filter media 129. The filter media 129 may be of various constructions so that the filter 128 is tailored for a target application. In some embodiments, the filter media 129 may be a nanofiber media that contains no cellulose fibers. In these embodiments, the filter media 129 may be substantially waterproof. Such embodiments may be beneficial in applications where the vehicle 100 traverses surfaces that are wet.

In some embodiments, the filter media 129 may be, or may include a cellulose media. In some embodiments, the filter media 129 may be, or may include a synthetic (e.g., polyester, etc.) media. In some embodiments, the filter media 129 may be, or may include a ceramic (e.g., glass, etc.) media. The filter media 129 may include a single stage (e.g., layer, etc.) or a plurality (e.g., two, three, four, etc.) of stages. In some embodiments, the filter media includes a first meltblown later, a second meltblown layer, a nanofiber layer, and a support layer, with the second meltblown layer being positioned between the first meltblown layer and the nanofiber layer being positioned between the second meltblown layer and the support layer. In some embodiments, the filter media 129 may be similar to filter media in a diesel particulate filter (DPF), a cabin air filter, an intake air filter, or other similar filters.

In various embodiments, the filter 128 also includes a filter sensing array 130 (e.g., air flow sensor, mass air flow sensor, saturation sensor, etc.). The filter sensing array 130 is configured to measure parameters (e.g., air flow, mass air flow, voltage, etc.) associated with an amount of particulates collected in the filter media 129. In some embodiments, the filter sensing array 130 includes a first air flow sensor (e.g., mass air flow sensor, etc.) disposed upstream of the filter media 129 and a second air flow sensor disposed downstream of the filter media 129. By comparing a parameter measured by both of the air flow sensors, the filter sensing array 130 can determine a resistance provided by the filter media 129. By comparing this resistance to a threshold resistance, a determination can be made as to whether replacement of the filter 128 would be advisable. The filter sensing array 130 may be configured to determine an amount of particulates collected within the filter media 129 by, for example, differential pressure, radio frequency transmission, computer algorithms based on a speed of the vehicle 100, a duration of braking of the vehicle 100, an intensity of braking of the vehicle 100, and other similar parameters.

The particulate collection system 118 also includes a fan conduit 131 (e.g., pipe, tube, etc.). The fan conduit 131 is fluidly coupled to the filter 128 and is configured to receive the air from the filter 128. The particulate collection system 118 also includes a fan 132 (e.g., blower, centrifugal fan, axial fan, etc.). The fan 132 is configured to receive the air from the fan conduit 131. The fan 132 creates a suction force that is provided through the fan conduit 131, the filter 128, the filter conduit 126, the main conduit 124, the collecting conduits 122, and the ducts 120.

The fan 132 includes a fan drive 134 and a fan blade 136. The fan drive 134 is configured to drive (e.g., rotate, spin, power, etc.) rotation of the fan blade 136. The fan drive 134 may include a transmission (e.g., gear reducer, variable transmission, etc.). In some embodiments, the fan 132 is similar to a cabin air blower. The fan drive 134 may be a single speed fan drive or a variable speed fan drive. The fan drive 134 may drive the fan blade 136 at a speed that is proportional to a speed of the vehicle 100. For example, as the speed of the vehicle 100 increases, the speed that the fan drive 134 drives the fan blade 136 may also increase.

In some embodiments, the fan drive 134 may be a motor (e.g., electric motor, servo motor, direct drive motor, etc.). The fan drive 134 may be powered by a battery. For example, the fan drive 134 may be powered by the same battery as the vehicle 100 (e.g., when the vehicle 100 is an electrical vehicle, when the vehicle 100 is a hybrid vehicle, etc.). In some embodiments, rotation of the fan blade 136 may be independent of rotation of any other component of the vehicle 100. This may be useful to, for example, operate the particulate collection system 118 when the vehicle 100 is not moving. For example, the particulate collection system 118 may be periodically operated when the vehicle 100 is not operated. This may enable the particulate collection system 118 to perform a “deep clean” by operating the fan blade 136 at high speeds with the vehicle 100 stationary. This may also enable the particulate collection system 118 to remove particulates from the surrounding environment when the vehicle 100 is stationary (e.g., within a garage, at a construction site, etc.). As a result, the vehicle 100 may qualify for an emissions credit from a certifying or regulatory agency.

In some embodiments, the fan drive 134 couples rotation of the fan blade 136 to another component of the vehicle 100. In these embodiments, rotation of the fan blade 136 is achieved without including a dedicated component. For example, the fan drive 134 may be a belt drive that is driven via a belt by another device (e.g., pulley, etc.). In some embodiments, the fan drive 134 is driven via rotation of one of the movement members 108. For example, the fan drive 134 may be configured to be driven by rotation of an axle to which at least one of the movement members 108 is coupled such that rotation of the movement member causes rotation of the fan blade 136. In these embodiments, the fan drive 134 may include various sensors (e.g., air flow sensors, mass air flow sensors, rotational speed sensors, voltage sensors, etc.) that are configured to determine a rotational speed of the fan blade 136.

The particulate collection system 118 also includes an exhaust conduit 138 (e.g., pipe, tube, etc.). The exhaust conduit 138 provides the particulates and/or air out of the particulate collection system 118. In various embodiments, the exhaust conduit 138 provides the particulates and/or air to atmosphere. In other embodiments, the exhaust conduit 138 routes the particulates and/or air to other locations in the vehicle 100. For example, the exhaust conduit 138 routes the particulates and/or air around various components (e.g., engine, motor, battery, etc.) of the engine to provide cooling to those components in some embodiments. In various embodiments, the vehicle 100 is an electric vehicle having a battery and a battery cooling system that receives the air from the exhaust conduit 138 and routes the air across the battery so as to provide the battery with cooling and ensure desirable operation of the vehicle 100. In such embodiments, the particulate collection system 118 is able to supplement or replace typical cooling systems for the battery and thereby may reduce the cost of the vehicle 100.

The particulate collection system 118 is at least partially coupled to the chassis 102. For example, the ducts 120, the collecting conduits 122, the main conduit 124, the filter conduit 126, the filter 128, the fan conduit 131, the fan 132, and/or the exhaust conduit 138 may be coupled to the chassis 102 using, for example, fasteners (e.g., bolts, etc.), welds, or hangers (e.g., exhaust hangers, hardware hanger, band clamps, etc.).

The particulate collection system 118 also includes a controller 140 (e.g., control unit, etc.). The controller 140 is communicable with the filter sensing array 130 and the fan drive 134. The controller 140 includes a processing circuit 142. The processing circuit 142 includes a processor 144 and a memory 146. The processor 144 may include a microprocessor, an application-specific integrated circuit (ASIC), a field-programmable gate array (FPGA), etc., or combinations thereof. The memory 146 may include, but is not limited to, electronic, optical, magnetic, or any other storage or transmission device capable of providing a processor, ASIC, FPGA, etc. with program instructions. This memory 146 may include a memory chip, Electrically Erasable Programmable Read-Only Memory (EEPROM), Erasable Programmable Read Only Memory (EPROM), flash memory, or any other suitable memory from which the controller 140 can read instructions. The instructions may include code from any suitable programming language. The memory 146 may include various modules that include instructions which are configured to be implemented by the processor 144.

The controller 140 is configured to communicate with a central controller (e.g., engine control unit (ECU)), engine control module (ECM), etc.) of the vehicle 100. In some embodiments, the central controller and the controller 140 are integrated into a single controller.

The memory 146 includes various modules which are capable of being implemented by the processor 144 to cause various processes to take place. In various embodiments, the memory 146 includes a filter status module 148, a fan speed module 150, and a scheduling module 152.

The filter status module 148 may include a particulate threshold and be configured to receive measurements from the filter sensing array 130, correlate these measurements to an amount of particulate collected in the filter media 129, determine if the amount of particulate collected in the filter media 129 is greater than the particulate threshold, and, if the amount of particulate collected in the filter media 129 is greater than the particulate threshold, indicate that replacement of the filter 128 would be advisable. This indication may be conveyed via, for example, a display or indicator light in a cab of the vehicle 100.

The fan speed module 150 may be configured to cause the fan drive 134 to rotate the fan blade 136 at a target speed (e.g., rotational speed, etc.). For example, where the fan drive 134 is a motor, the fan speed module 150 may control the voltage and/or current provided to the fan drive 134. In embodiments where the fan drive 134 includes a transmission, the fan speed module 150 may cause shifting of the transmission. In embodiments where the fan blade 136 is directly driven by a component of the vehicle other than a motor, the fan speed module 150 may determine a speed of rotation of the fan blade 136 (e.g., via sensors in the fan drive 134).

The fan speed module 150 may also be configured to cause the fan blade 136 to produce a target suction force at the ducts 120. By controlling the suction force at the ducts 120 to be below a threshold associated with certain non-particulate substances, the fan speed module 150 can operate to minimize the transmission of non-particulate substances into the particulate collection system 118. The fan speed module 150 may also be configured to drive the fan blade 136 at a speed that is related to a speed of the vehicle 100. For example, as the speed of the vehicle 100 increases, the fan speed module 150 may be configured to increase the speed at which the fan blade 136 is driven.

The scheduling module 152 may be utilized when the fan drive 134 is a motor. In such embodiments, the fan blade 136 may be rotated when the vehicle 100 is stationary, such as when the vehicle 100 is parked or stored within a garage. In this way, the scheduling module 152 may enable the vehicle 100 to periodically remove particulates from the surrounding atmosphere. As a result, the vehicle 100 may qualify for an emissions credit from a certifying or regulatory agency. The scheduling module 152 may also be utilized to periodically cause rotation of the fan blade 136 when the vehicle is stationary so as to collect any particulate resting on the vehicle 100. This may be useful in performing a deep clean of the vehicle 100. The scheduling module 152 may enable this deep clean to be performed at regular intervals (e.g., 30 minutes after the vehicle 100 is turned off, once a week, etc.), thereby minimizing the particulate that has to be removed when the vehicle 100 is not stationary.

### III. Construction of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “approximately,” “generally,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The terms “fluidly coupled to,” “fluidly configured to communicate with,” and the like, as used herein, mean the two components or objects have a pathway formed between the two components or objects in which a fluid, such as air, may flow, either with or without intervening components or objects. Examples of fluid couplings or configurations for enabling fluid communication may include piping, conduits, channels, or any other suitable components for enabling the flow of a fluid from one component or object to another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language “a portion” is used, the item can include a portion and/or the entire item unless specifically stated to the contrary.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

What is claimed is:

1. A collection system for a vehicle that comprises a chassis supporting the vehicle above a ground surface, a braking system coupled to the chassis, and a movement member supporting the chassis on the ground surface, the collection system comprising:
a first duct configured to be coupled to the chassis proximate at least one of the braking system or the movement member such that the first duct is positioned proximate to the at least one of braking system or the movement member;
a first collecting conduit fluidly coupled to the first duct;
a filter fluidly coupled to the first collecting conduit; and
a fan fluidly coupled to the filter and configured to create a suction force;
wherein the fan, the filter, and the first collecting conduit are configured to provide the suction force to the first duct.

2. The collection system of claim 1, further comprising:
a screen coupled to the first duct, the screen defined by an opening size and configured to facilitate passage of particulates that are smaller than the opening size and to substantially prohibit passage of particulates that are larger than the opening size.

3. The collection system of claim 1, wherein:
the first duct is positioned behind the at least one of the braking system or the movement member.

4. The collection system of claim 1, wherein:
the first duct is positioned above the at least one of the braking system or the movement member.

5. The collection system of claim 1, wherein:
the first duct is positioned axially offset along a center axis of the movement member and relative to at least one of the movement member or the braking system.

6. The collection system of claim 1, wherein:
the first duct, the fan, the filter, and the first collecting conduit are configured to draw particulates produced by at least one of the movement member or the braking system, to the filter.

7. The collection system of claim 6, further comprising:
an exhaust conduit fluidly coupled to the fan and atmosphere;
wherein the fan is disposed between the filter and the exhaust conduit; and
wherein the first collecting conduit is disposed between the filter and the first duct.

8. The collection system of claim 1, further comprising:
a second duct configured to be coupled to the chassis and fluidly coupled to the first collecting conduit; and
a main conduit fluidly coupled to the first collecting conduit and the filter, the main conduit disposed between the first collecting conduit and the filter;
wherein the first collecting conduit is disposed between the main conduit and the first duct, and between the main conduit and the second duct; and
wherein the fan, the filter, and the main conduit are configured to provide the suction force to the second duct.

9. The collection system of claim 1, further comprising:
a main conduit fluidly coupled to the first collecting conduit and the filter, the main conduit disposed between the first collecting conduit and the filter;
a second collecting conduit fluidly coupled to the main conduit; and
a second duct configured to be coupled to the chassis and fluidly coupled to the second collecting conduit;
wherein the second collecting conduit is disposed between the main conduit and the second duct;
wherein the main conduit is disposed between the second collecting conduit and filter; and
wherein the fan, the filter, the main conduit, and the second collecting conduit are configured to provide the suction force to the second duct.

10. The collection system of claim 1, further comprising:
a controller communicable with the fan;
wherein the fan comprises:
a fan blade; and
a fan drive that is configured to rotate the fan blade at a fan speed proportional to a vehicle speed of the vehicle.

11. A vehicle comprising:
the chassis;
the braking system;
the movement member; and
the collection system of claim 1;
wherein the first duct is coupled to the chassis proximate at least one of the braking system or the movement member such that the first duct is positioned proximate to the at least one of the braking system or the movement member.

12. A collection system for a vehicle that comprises a chassis supporting the vehicle above a ground surface and a movement member supporting the chassis on the ground surface, the collection system comprising:
a first duct configured to be coupled to the chassis proximate the movement member such that the first duct is positioned proximate to the movement member;
a first collecting conduit fluidly coupled to the first duct;
a filter fluidly coupled to the first collecting conduit; and
a fan fluidly coupled to the filter and configured to create a suction force;
wherein the fan, the filter, and the first collecting conduit are configured to provide the suction force to the first duct.

13. The collection system of claim 12, further comprising:
a second duct configured to receive particulate from a particulate source;
a main conduit fluidly coupled to the first duct and the second duct, the main conduit disposed between the first duct and the filter and between the second duct and the filter; and
an exhaust conduit fluidly coupled to the filter and atmosphere;
wherein the filter is fluidly coupled to the main conduit;
wherein the first duct, the main conduit, the filter, and the exhaust conduit are configured to cooperate to draw the particulate from the movement member into the collection system and to provide the particulate from the particulate source to atmosphere; and
wherein the second duct, the main conduit, the filter, and the exhaust conduit are configured to cooperate to draw the particulate from the particulate source into the collection system and to provide the particulate from the particulate source to atmosphere.

14. The collection system of claim 13, further comprising:
a first collecting conduit fluidly coupled to the first duct, the second duct, and the main conduit, the first collecting conduit separating the first duct from the main conduit and separating the second duct from the main conduit;
a second collecting conduit fluidly coupled to the second duct and the main conduit, the second collecting conduit separating the second duct from the main conduit;
wherein the main conduit separates the second collecting conduit from the first collecting conduit.

15. A vehicle comprising:
the chassis;
the movement member; and
the collection system of claim 12;
wherein the first duct is coupled to the chassis proximate the movement member such that the first duct is positioned proximate to the movement member.

16. A collection system for a vehicle that comprises a chassis and a braking system coupled to the chassis, the collection system comprising:
a duct configured to be coupled to the chassis proximate the braking system such that the duct is positioned proximate to the braking system;
a collecting conduit fluidly coupled to the duct;
a filter fluidly coupled to the collecting conduit; and
a fan fluidly coupled to the filter and configured to create a suction force;
wherein the fan, the filter, and the collecting conduit are configured to provide the suction force to the duct.

17. A vehicle comprising:
the chassis;
the braking system; and
the collection system of claim 16;
wherein the duct is coupled to the chassis proximate the braking system such that the duct is positioned proximate to the braking system.

18. The vehicle of claim 17, wherein:
the vehicle is defined by a primary direction of travel; and
the duct is positioned behind the braking system in the primary direction of travel.

19. The vehicle of claim 17, wherein:
the vehicle is defined by a primary direction of travel and a first center axis that is parallel to the primary direction of travel;
the braking system is for a movement member defined by a second center axis; and
the duct is axially offset from the braking system along the second center axis and towards the first center axis.

20. The vehicle of claim 17, wherein the braking system comprises:
a rotor;
a friction member; and
a friction member actuator configured to cause the friction member to contact the rotor.
